(19) United States
(12) Patent Application Publication
(10) Pub. No.: US 2025/0141617 A1
(43) Pub. Date: May 1, 2025

(54) APPARATUS AND METHODS FOR MITIGATING ANTENNA PUNCTURING ARISING FROM SOUNDING REFERENCE SIGNALING

(71) Applicant: Skyworks Solutions, Inc., Irvine, CA (US)

(72) Inventors: Anand Raghavan, Middleton, WI (US); David Richard Pehlke, Westlake Village, CA (US)

(21) Appl. No.: 18/931,520

(22) Filed: Oct. 30, 2024

Related U.S. Application Data
(60) Provisional application No. 63/546,898, filed on Nov. 1, 2023.
(60) Provisional application No. 63/631,639, filed on Apr. 9, 2024.

(51) Int. Cl. H04L 5/00; H04W 72/0453

(52) U.S. Cl. CPC H04L 5/0048; H04W 72/0453

(57) ABSTRACT

Apparatus and methods for mitigating antenna puncturing arising from sounding reference signaling (SRS) are disclosed. In certain embodiments, a mobile device includes a front-end system operable to transmit over a first frequency band and to a receive over a second frequency band. The mobile device includes a radio operable to detect an antenna puncturing scenario arising from SRS signaling for the first frequency band for a first radio configuration in which each antenna of a group of antennas are used for receiving a data layer of the second frequency band. In response to detecting the antenna puncturing scenario, the radio indicates to a base station a second radio configuration in which a subset of the group of antennas are used at a given time for receiving the second frequency band to avoid the antenna puncturing scenario.

### CROSS-REFERENCE TO RELATED APPLICATIONS

This application claims the benefit of priority under 35 U.S.C. § 119 of U.S. Provisional Patent Application No. 63/631,639, filed Apr. 9, 2024 and titled “APPARATUS AND METHODS FOR MITIGATING ANTENNA PUNCTURING ARISING FROM SOUNDING REFERENCE SIGNALING,” and of U.S. Provisional Patent Application No. 63/546,898, filed Nov. 1, 2023 and titled “APPARATUS AND METHODS FOR MITIGATING ANTENNA PUNCTURING ARISING FROM SOUNDING REFERENCE SIGNALING,” each of which is herein incorporated by reference in its entirety.

### BACKGROUND

### Field

Embodiments of the invention relate to electronic systems, and in particular, to radio frequency electronics.

### Description of Related Technology

Radio frequency (RF) communication systems can be used for transmitting and/or receiving signals of a wide range of frequencies. For example, an RF communication system can be used to wirelessly communicate RF signals in a frequency range of about 30 kHz to 300 GHz, such as in the range of about 400 MHz to about 7.125 GHz for Frequency Range 1 (FR1) of the Fifth Generation (5G) communication standard or in the range of about 24.250 GHz to about 71.000 GHz for Frequency Range 2 (FR2) of the 5G communication standard.

Examples of RF communication systems include, but are not limited to, mobile phones, tablets, base stations, network access points, customer-premises equipment (CPE), laptops, and wearable electronics.

### SUMMARY

In certain embodiments, the present disclosure relates to a mobile device. The mobile device includes a plurality of antennas, a front-end system coupled to the plurality of antennas and configured to transmit over a first frequency band and to a receive over a second frequency band, and a radio configured to control the front-end system to perform a sounding reference signaling for the first frequency band on the plurality of antennas. The radio is operable to detect an antenna puncturing scenario arising from the sounding reference signaling for a first radio configuration in which each antenna of the plurality of antennas is used for receiving a corresponding data layer of the second frequency band, the radio further configured to indicate to a base station a second radio configuration in which a subset of the antennas are used at a given time for receiving the second frequency band to avoid the antenna puncturing scenario.

In several embodiments, the subset of the antennas is selected in hardware. According to a number of embodiments, the subset of the antennas is selected using at least one switch in the front-end system or radio.

In various embodiments, the subset of the antennas is selected using software in the radio.

In some embodiments, the subset of the antennas is dynamically changed by the radio over time.

In several embodiments, the subset of the antennas excludes a punctured antenna. According to a number of embodiments, the punctured antenna is used by the radio for signal diversity.

In various embodiments, the radio decodes a plurality of data layers received from a base station on the plurality of antennas, a number of the plurality of antennas greater than a number of the plurality of data layers.

In several embodiments, the second radio configuration has a multiple-input multiple-output order that is smaller than that of the first radio configuration. According to a number of embodiments, the first radio configuration has a 4×4 order and the second radio configuration has a 4×2 order or a 4×3 order.

In some embodiments, the first frequency band is a general time-division duplexed band supporting SRS-AS operation, and the second frequency band is one of a frequency-division duplexed band or a time-division duplexed band within a same band group as the first frequency band and whose passband is close in frequency proximity to the first frequency band, and in architectural connections to the antenna interface. According to a number of embodiments, a passband of the second frequency band is in close frequency proximity to the first frequency band and connected to the plurality of antennas through a common front-end system.

In various embodiments, the first frequency band is n41 and the second frequency band is n25.

In several embodiments, the second radio configuration is established by a capability signaling from the mobile device to a base station.

In some embodiments, the first frequency band is a fifth generation frequency band that is time-division duplexed. According to a number of embodiments, the second frequency band is fourth generation frequency band serving as an anchor carrier for dual connectivity. In accordance with several embodiments, the second frequency band is a fifth generation frequency band for carrier aggregation. According to various embodiments, the second frequency band is frequency-division duplexed. In accordance with a number of embodiments, the second frequency band is time-division duplexed and asynchronous with the first frequency band.

In certain embodiments, the present disclosure relates to a method of radio frequency communication. The method includes transmitting over a first frequency band and receiving over a second frequency band using a front-end system of a mobile device, controlling the front-end system to perform a sounding reference signaling for the first frequency band on a plurality of antennas of the mobile device, detecting an antenna puncturing scenario arising from the sounding reference signaling for a first radio configuration in which each antenna of the plurality of antennas is used for receiving a corresponding data layer of the second frequency band, and indicating to a base station a second radio configuration in which a subset of the antennas are used at a given time for receiving the second frequency band to avoid the antenna puncturing scenario.

In some embodiments, the method further includes selecting the subset of the antennas using hardware of the mobile device. In a number of embodiments, the method further includes selecting the subset of the antennas using at least one switch of the mobile device.

In several embodiments, the method further includes selecting the subset of the antennas using software of the mobile device.

In various embodiments, the method further includes dynamically changing the subset of the antennas over time.

In some embodiments, the subset of the group of antennas excludes a punctured antenna. According to a number of embodiments, the method further includes using the punctured antenna for signal diversity.

In several embodiments, the method further includes decoding a plurality of data layers received from a base station on the plurality of antennas using the radio, a number of the plurality of antennas greater than a number of the plurality of data layers.

In various embodiments, the second radio configuration has a multiple-input multiple-output order that is smaller than that of the first radio configuration. According to a number of embodiments, the first radio configuration has a 4×4 order and the second radio configuration has a 4×2 order or a 4×3 order.

In several embodiments, the first frequency band is a general time-division duplexed band supporting SRS-AS operation, and the second frequency band is one of a frequency-division duplexed band or a time-division duplexed band within a same band group as the first frequency band and whose passband is close in frequency proximity to the first frequency band, and in architectural connections to the antenna interface. According to a number of embodiments, a passband of the second frequency band is in close frequency proximity to the first frequency band and connected to the plurality of antennas through a common front-end system.

In some embodiments, the first frequency band is n41 and the second frequency band is n25.

In various embodiments, the method further includes establishing the second radio configuration by a capability signaling from the mobile device to a base station.

In several embodiments, the first frequency band is a fifth generation frequency band that is time-division duplexed. According to a number of embodiments, the second frequency band is fourth generation frequency band serving as an anchor carrier for dual connectivity. In accordance with various embodiments, the second frequency band is a fifth generation frequency band for carrier aggregation. According to some embodiments, the second frequency band is frequency-division duplexed. In accordance with a number of embodiments, the second frequency band is time-division duplexed and asynchronous with the first frequency band.

In certain embodiments, the present disclosure relates to a radio system for user equipment. The radio system includes a front-end system configured to transmit over a first frequency band and to a receive over a second frequency band, and a radio configured to control the front-end system to perform a sounding reference signaling for the first frequency band, the radio operable to detect an antenna puncturing scenario arising from the sounding reference signaling for a first radio configuration in which each antenna of the plurality of antennas is used for receiving a corresponding data layer of the second frequency band, the radio further configured to indicate to a base station a second radio configuration in which a subset of the antennas are used at a given time for receiving the second frequency band to avoid the antenna puncturing scenario.

In various embodiments, the subset of the antennas is selected in hardware. According to several embodiments, the subset of the antennas is selected using at least one switch in the front-end system or radio.

In some embodiments, the subset of the antennas is selected using software in the radio.

In various embodiments, the subset of the antennas is dynamically changed by the radio over time.

In several embodiments, the subset of the antennas excludes a punctured antenna. According to a number of embodiments, the punctured antenna is used by the radio for signal diversity.

In some embodiments, the radio decodes a plurality of data layers received from a base station on the plurality of antennas, a number of the plurality of antennas greater than a number of the plurality of data layers.

In various embodiments, the second radio configuration has a multiple-input multiple-output order that is smaller than that of the first radio configuration. According to a number of embodiments, the first radio configuration has a 4×4 order and the second radio configuration has a 4×2 order or a 4×3 order.

In several embodiments, the first frequency band is a general time-division duplexed band supporting SRS-AS operation, and the second frequency band is one of a frequency-division duplexed band or a time-division duplexed band within a same band group as the first frequency band and whose passband is close in frequency proximity to the first frequency band, and in architectural connections to the antenna interface. According to a number of embodiments, a passband of the second frequency band is in close frequency proximity to the first frequency band and connected to the plurality of antennas through a common front-end system.

In various embodiments, the first frequency band is n41 and the second frequency band is n25.

In some embodiments, the second radio configuration is established by a capability signaling from the mobile device to a base station.

In several embodiments, the first frequency band is a fifth generation frequency band that is time-division duplexed. According to a number of embodiments, the second frequency band is fourth generation frequency band serving as an anchor carrier for dual connectivity. In accordance with various embodiments, the second frequency band is a fifth generation frequency band for carrier aggregation. According to some embodiments, the second frequency band is frequency-division duplexed. In accordance with a number of embodiments, the second frequency band is time-division duplexed and asynchronous with the first frequency band.

In certain embodiments, the present disclosure relates to a mobile device. The mobile device includes a plurality of antennas, a front-end system coupled to the plurality of antennas and configured to transmit over a first frequency band and to a receive over a second frequency band. The front-end system including a plurality of data paths of the second frequency band each associated with a corresponding one of the plurality of antennas. The mobile device further includes a radio configured to control the front-end system to perform a sounding reference signaling for the first frequency band on the plurality of antennas, the radio further configured to decode all of the plurality of data paths for a radio configuration in which a subset of the plurality of antennas are used for receiving data layers of the second frequency band, the radio configuration avoiding an antenna puncturing scenario arising from the sounding reference signaling.

In various embodiments, the plurality of data paths that are decoded includes a punctured data path associated with a punctured antenna of the plurality of antennas.

In several embodiments, the plurality of data paths includes four data paths, and the radio configuration has a 4×2 order or a 4×3 order.

In some embodiments, the first frequency band is a general time-division duplexed band supporting SRS-AS operation. According to a number of embodiments, the second frequency band is one of a frequency-division duplexed band or a time-division duplexed band within a same band group as the first frequency band. In accordance with several embodiments, a passband of the second frequency band is in close frequency proximity to the first frequency band.

In various embodiments, the first frequency band is n41 and the second frequency band is n25.

In some embodiments, the radio configuration is established by a capability signaling from the mobile device to a base station.

In several embodiments, the first frequency band is a fifth generation frequency band that is time-division duplexed. According to a number of embodiments, the second frequency band is fourth generation frequency band serving as an anchor carrier for dual connectivity.

In some embodiments, the second frequency band is a fifth generation frequency band for carrier aggregation.

In various embodiments, the second frequency band is frequency-division duplexed.

In several embodiments, the second frequency band is time-division duplexed and asynchronous with the first frequency band.

In some embodiments, an uplink symbol for the sounding reference signaling for the first frequency band is time-aligned by the base station with a downlink symbol for the second frequency band.

In certain embodiments, the present disclosure relates to a method of radio frequency communication. The method includes transmitting over a first frequency band and receiving over a second frequency band using a front-end system of a mobile device, the front-end system including a plurality of data paths of the second frequency band each associated with a corresponding one of a plurality of antennas of a mobile device. The method further includes controlling the front-end system to perform a sounding reference signaling for the first frequency band on the plurality of antennas, and decoding all of the plurality of data paths using the radio for a radio configuration in which a subset of the antennas are used for receiving data layers of the second frequency band, the radio configuration avoiding an antenna puncturing scenario arising from the sounding reference signaling.

In various embodiments, the plurality of data paths that are decoded includes a punctured data path associated with a punctured antenna of plurality of antennas.

In some embodiments, the plurality of data paths includes four data paths, and the radio configuration has a 4×2 order or a 4×3 order.

In several embodiments, the first frequency band is a general time-division duplexed band supporting SRS-AS operation. According to a number of embodiments, the second frequency band is one of a frequency-division duplexed band or a time-division duplexed band within a same band group as the first frequency band. In accordance with some embodiments, a passband of the second frequency band is in close frequency proximity to the first frequency band.

In various embodiments, the first frequency band is n41 and the second frequency band is n25.

In some embodiments, the method further includes establishing the radio configuration by a capability signaling from the mobile device to a base station.

In several embodiments, the first frequency band is a fifth generation frequency band that is time-division duplexed. According to a number of embodiments, the second frequency band is fourth generation frequency band serving as an anchor carrier for dual connectivity.

In various embodiments, the second frequency band is a fifth generation frequency band for carrier aggregation.

In some embodiments, the second frequency band is frequency-division duplexed.

In several embodiments, the second frequency band is time-division duplexed and asynchronous with the first frequency band.

In various embodiments, an uplink symbol for the sounding reference signaling for the first frequency band is time-aligned by the base station with a downlink symbol for the second frequency band.

In certain embodiments, the present disclosure relates to a radio system for user equipment. The radio system includes a front-end system configured to transmit over a first frequency band and to a receive over a second frequency band, the front-end system including a plurality of data paths of the second frequency band each associated with a corresponding one of a plurality of antennas. The radio system further includes a radio configured to control the front-end system to perform a sounding reference signaling for the first frequency band on the plurality of antennas, the radio further configured to decode all of the plurality of data paths for a radio configuration in which a subset of the plurality of antennas are used for receiving data layers of the second frequency band, the radio configuration avoiding an antenna puncturing scenario arising from the sounding reference signaling.

In various embodiments, the plurality of data paths that are decoded includes a punctured data path associated with a punctured antenna of the plurality of antennas.

In several embodiments, the plurality of data paths includes four data paths, and the radio configuration has a 4×2 order or a 4×3 order.

In some embodiments, the first frequency band is a general time-division duplexed band supporting SRS-AS operation. According to various embodiments, the second frequency band is one of a frequency-division duplexed band or a time-division duplexed band within a same band group as the first frequency band. In accordance with a number of embodiments, a passband of the second frequency band is in close frequency proximity to the first frequency band.

In several embodiments, the first frequency band is n41 and the second frequency band is n25.

In some embodiments, the radio configuration is established by a capability signaling from the mobile device to a base station.

In various embodiments, the first frequency band is a fifth generation frequency band that is time-division duplexed. According to a number of embodiments, the second frequency band is fourth generation frequency band serving as an anchor carrier for dual connectivity.

In several embodiments, the second frequency band is a fifth generation frequency band for carrier aggregation.

In some embodiments, the second frequency band is frequency-division duplexed.

In various embodiments, the second frequency band is time-division duplexed and asynchronous with the first frequency band.

In several embodiments, an uplink symbol for the sounding reference signaling for the first frequency band is time-aligned by the base station with a downlink symbol for the second frequency band.

### BRIEF DESCRIPTION OF THE DRAWINGS

FIG. 1 is a schematic diagram of one example of a communication network.

FIG. 2A is a schematic diagram of one example of a communication link using carrier aggregation.

FIG. 2B illustrates various examples of uplink carrier aggregation for the communication link of FIG. 2A.

FIG. 2C illustrates various examples of downlink carrier aggregation for the communication link of FIG. 2A.

FIG. 3A is a schematic diagram of one example of a downlink channel using multi-input and multi-output (MIMO) communications.

FIG. 3B is schematic diagram of one example of an uplink channel using MIMO communications.

FIG. 3C is schematic diagram of another example of an uplink channel using MIMO communications.

FIG. 4 is a schematic diagram of an example dual connectivity network topology.

FIG. 5A is a schematic diagram of one example of a communication system that operates with beamforming.

FIG. 5B is a schematic diagram of one example of beamforming to provide a transmit beam.

FIG. 5C is a schematic diagram of one example of beamforming to provide a receive beam.

FIG. 6A is a schematic diagram of one embodiment of a front-end system.

FIG. 6B is a schematic diagram of another embodiment of a front-end system.

FIG. 6C is a schematic diagram of another embodiment of a front-end system coupled to a radio.

FIG. 7A is a graph of one example of throughput versus signal-to-noise ratio (SNR) for 4×4 4-layer 64 QAM with and without puncturing.

FIG. 7B is a graph of one example of throughput versus SNR for 4×2 2-layer 64 QAM without puncturing.

FIG. 7C is a graph of a first example of communication time slots for n25 and n41 communications.

FIG. 7D is a graph of a second example of communication time slots for n25 and n41 communications.

FIG. 8 is a schematic diagram of one embodiment of a mobile device.

### DETAILED DESCRIPTION OF EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15 and introduced Phase 2 of 5G technology in Release 16. Subsequent 3GPP releases will further evolve and expand 5G technology. 5G technology is also referred to herein as 5G New Radio (NR).

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

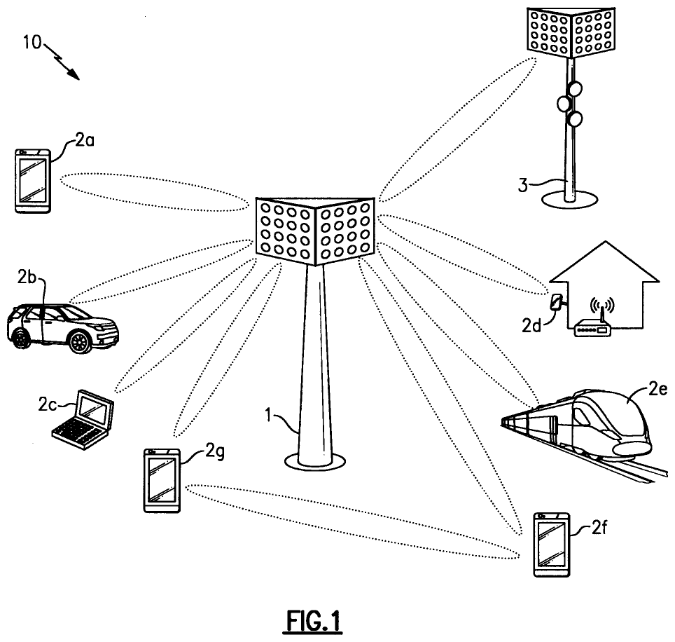

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE and 5G NR. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, and WiFi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul.

The communication links can operate over a wide variety of frequencies. In certain implementations, communications are supported using 5G NR technology over one or more frequency bands that are less than 6 Gigahertz (GHz) and/or over one or more frequency bands that are greater than 6 GHz. For example, the communication links can serve Frequency Range 1 (FR1), Frequency Range 2 (FR2), or a combination thereof. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz. Cellular user equipment can communicate using beamforming and/or other techniques over a wide range of frequencies, including, for example, FR2-1 (24 GHz to 52 GHz), FR2-2 (52 GHz to 71 GHz), and/or FR1 (400 MHz to 7125 MHz).

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

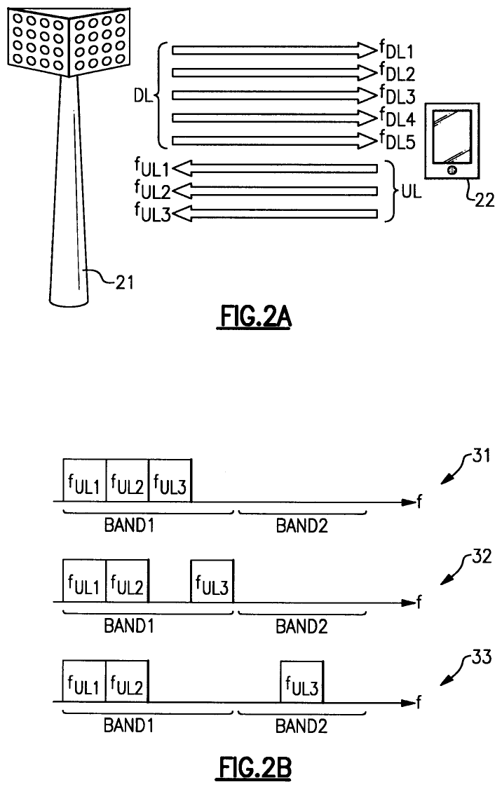

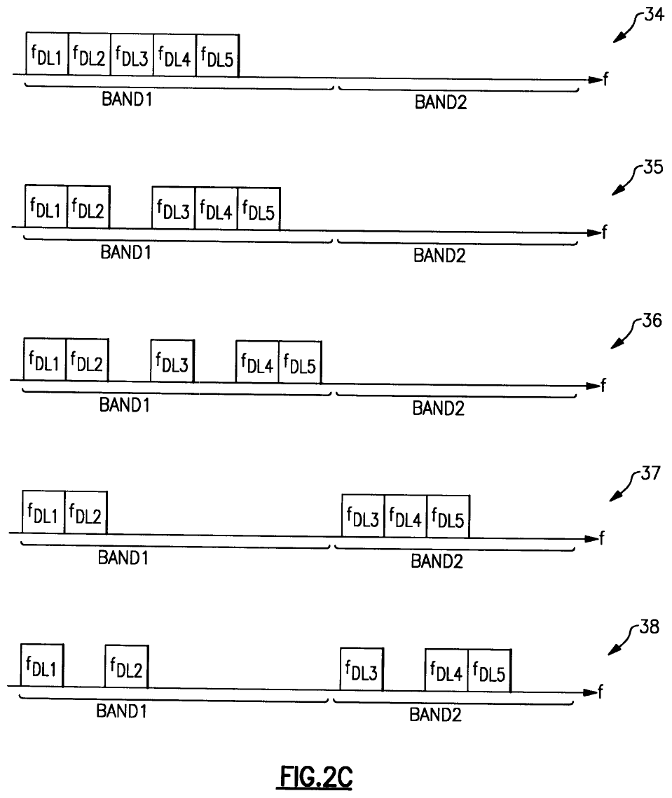

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous and can include carriers separated in frequency within a common band or in different bands.

In the example shown in FIG. 2A, the uplink channel includes three aggregated component carriers f_{UL1}, f_{UL2}, and f_{UL3}. Additionally, the downlink channel includes five aggregated component carriers f_{DL1}, f_{DL2}, f_{DL3}, f_{DL4}, and f_{DL5}. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of uplink carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier f_{UL1}, a second component carrier f_{UL2}, and a third component carrier f_{UL3}. Although FIG. 2B is illustrated in the context of aggregating three component carriers, carrier aggregation can be used to aggregate more or fewer carriers. Moreover, although illustrated in the context of uplink, the aggregation scenarios are also applicable to downlink.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers f_{UL1}, f_{UL2}, and f_{UL3} that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers f_{UL1}, f_{UL2}, and f_{UL3} that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers f_{UL1} and f_{UL2} of a first frequency band BAND1 with component carrier f_{UL3} of a second frequency band BAND2.

FIG. 2C illustrates various examples of downlink carrier aggregation for the communication link of FIG. 2A. The examples depict various carrier aggregation scenarios 34-38 for different spectrum allocations of a first component carrier f_{DL1}, a second component carrier f_{DL2}, a third component carrier f_{DL3}, a fourth component carrier f_{DL4}, and a fifth component carrier f_{DL5}. Although FIG. 2C is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous, but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2A-2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and second cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as WiFi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid WiFi users and/or to coexist with WiFi users. Enhanced license assisted access (eLAA) refers to an evolution of LAA that aggregates licensed and unlicensed spectrum for both downlink and uplink. Furthermore, NR-U can operate on top of LAA/eLAA over a 5 GHz band (5150 to 5925 MHz) and/or a 6 GHz band (5925 MHz to 7125 MHz).

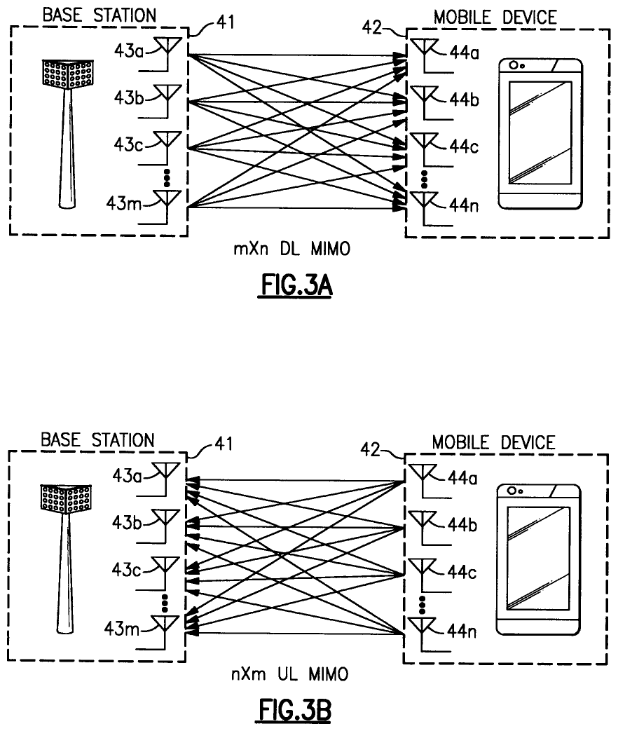

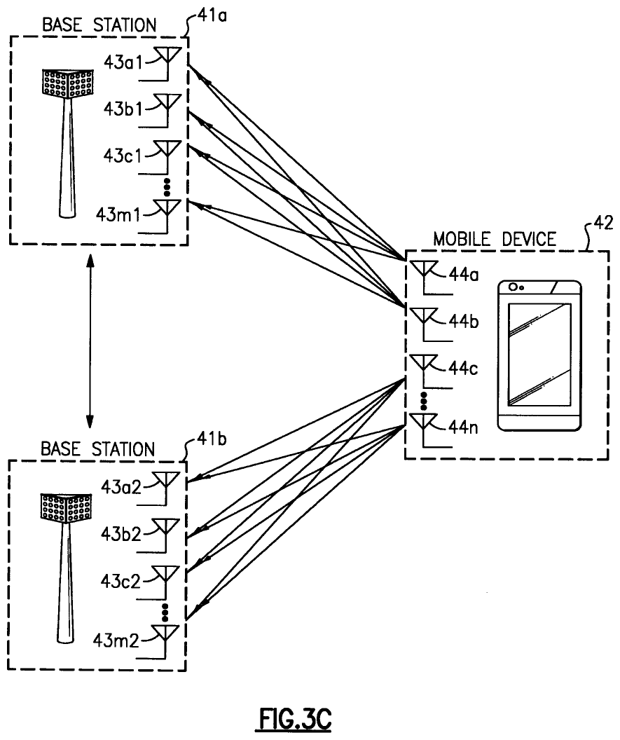

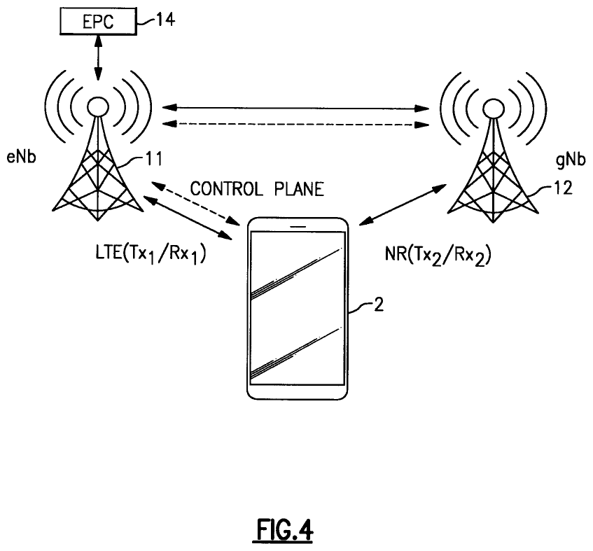

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, . . . 44n of the mobile device 42. Accordingly, FIG. 3A illustrates an example of m×n DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of n×m UL MIMO.

By increasing the level or order of MIMO, bandwidth of an uplink channel and/or a downlink channel can be increased.

MIMO communications are applicable to communication links of a variety of types, such as FDD communication links and TDD communication links.

FIG. 3C is schematic diagram of another example of an uplink channel using MIMO communications. In the example shown in FIG. 3C, uplink MIMO communications are provided by transmitting using N antennas 44a, 44b, 44c, . . . 44n of the mobile device 42. Additional a first portion of the uplink transmissions are received using M antennas 43a1, 43b1, 43c1, . . . 43m1 of a first base station 41a, while a second portion of the uplink transmissions are received using M antennas 43a2, 43b2, 43c2, . . . 43m2 of a second base station 41b. Additionally, the first base station 41a and the second base station 41b communication with one another over wired, optical, and/or wireless links.

The MIMO scenario of FIG. 3C illustrates an example in which multiple base stations cooperate to facilitate MIMO communications.

FIG. 4 is a schematic diagram of an example dual connectivity network topology. This architecture can leverage LTE legacy coverage to ensure continuity of service delivery and the progressive rollout of 5G cells. A UE 2 can simultaneously transmit dual uplink LTE and NR carrier. The UE 2 can transmit an uplink LTE carrier Tx1 to the eNB 11 while transmitting an uplink NR carrier Tx2 to the gNB 12 to implement dual connectivity. Any suitable combination of uplink carriers Tx1, Tx2 and/or downlink carriers Rx1, Rx2 can be concurrently transmitted via wireless links in the example network topology of FIG. 1. The eNB 11 can provide a connection with a core network, such as an Evolved Packet Core (EPC) 14. The gNB 12 can communicate with the core network via the eNB 11. Control plane data can be wireless communicated between the UE 2 and eNB 11. The eNB 11 can also communicate control plane data with the gNB 12. Control plane data can propagate along the paths of the dashed lines in FIG. 4. The solid lines in FIG. 4 are for data plane paths.

In the example dual connectivity topology of FIG. 4, any suitable combinations of standardized bands and radio access technologies (e.g., FDD, TDD, SUL, SDL) can be wirelessly transmitted and received. This can present technical challenges related to having multiple separate radios and bands functioning in the UE 2. With a TDD LTE anchor point, network operation may be synchronous, in which case the operating modes can be constrained to Tx1/Tx2 and Rx1/Rx2, or asynchronous which can involve Tx1/Tx2, Tx1/Rx2, Rx1/Tx2, Rx1/Rx2. When the LTE anchor is a frequency division duplex (FDD) carrier, the TDD/FDD inter-band operation can involve simultaneous Tx1/Rx1/Tx2 and Tx1/Rx1/Rx2.

As discussed above, EN-DC can involve both 4G and 5G carriers being simultaneously transmitted from a UE. Transmitting both 4G and 5G carriers in a UE, such as a phone, typically involves two power amplifiers (PAs) being active at the same time. Traditionally, having two power amplifiers active simultaneously would involve the placement of one or more additional power amplifiers specifically suited for EN-DC operation. Additional board space and expense is incurred when designing to support such EN-DC/NSA operation.

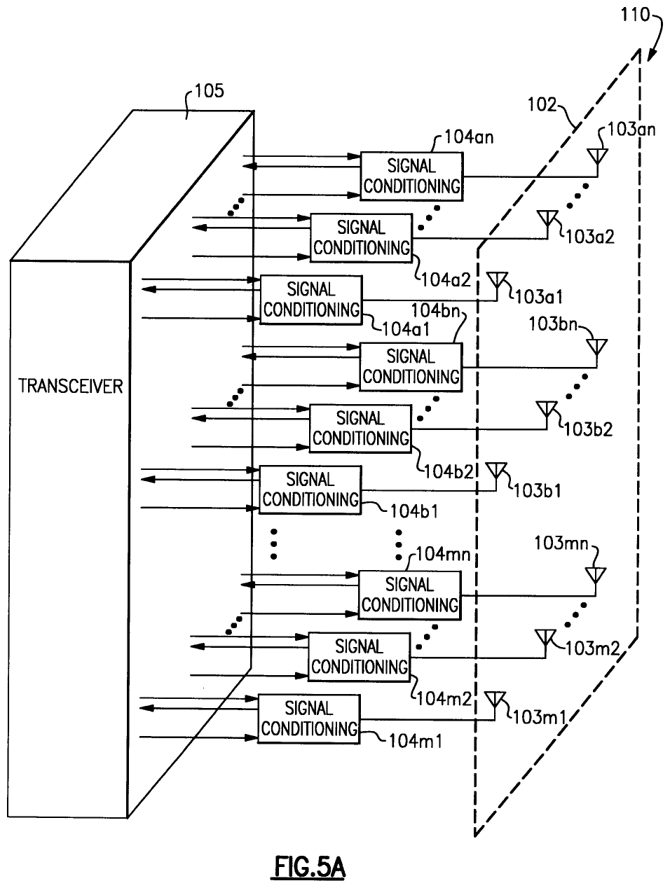

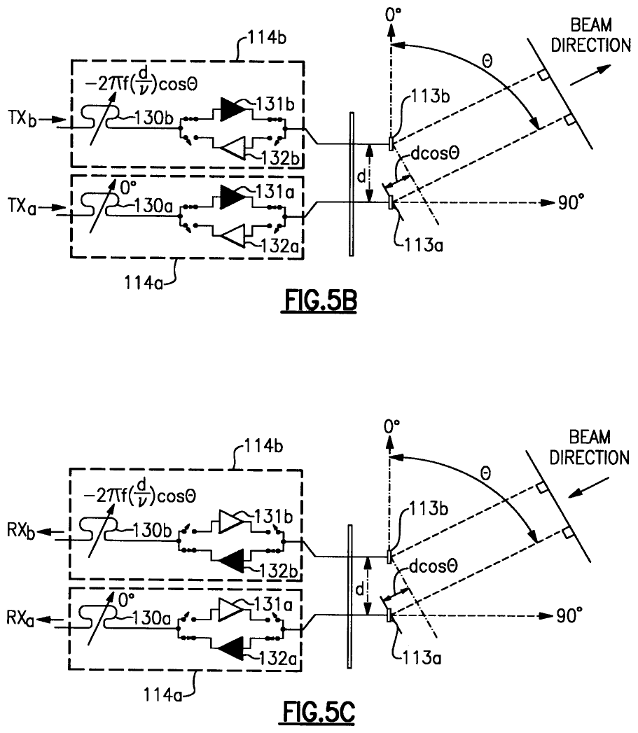

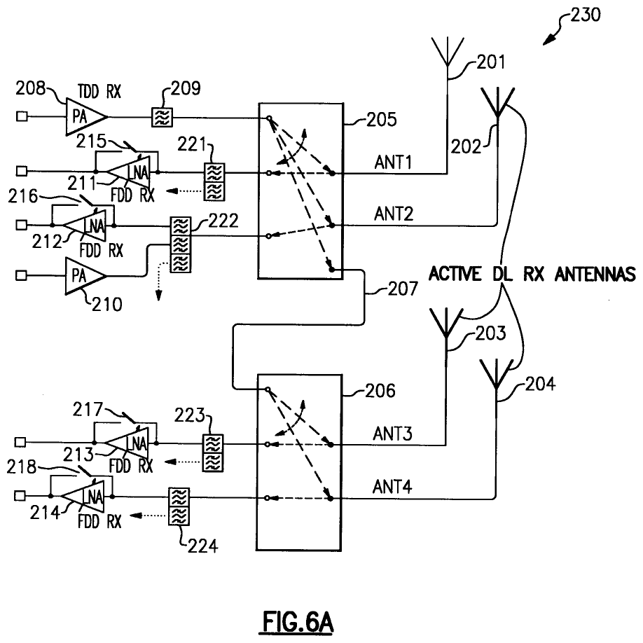

FIG. 5A is a schematic diagram of one example of a communication system 110 that operates with beamforming. The communication system 110 includes a transceiver 105, signal conditioning circuits 104a1, 104a2 . . . 104an, 104b1, 104b2 . . . 104bn, 104m1, 104m2 . . . 104mn, and an antenna array 102 that includes antenna elements 103a1, 103a2 . . . 103an, 103b1, 103b2 . . . 103bn, 103m1, 103m2 . . . 103mn.

Communications systems that communicate using millimeter wave carriers (for instance, 30 GHz to 300 GHz), centimeter wave carriers (for instance, 3 GHz to 30 GHz), and/or other frequency carriers can employ an antenna array to provide beam formation and directivity for transmission and/or reception of signals.

For example, in the illustrated embodiment, the communication system 110 includes an array 102 of m×n antenna elements, which are each controlled by a separate signal conditioning circuit, in this embodiment. As indicated by the ellipses, the communication system 110 can be implemented with any suitable number of antenna elements and signal conditioning circuits.

With respect to signal transmission, the signal conditioning circuits can provide transmit signals to the antenna array 102 such that signals radiated from the antenna elements combine using constructive and destructive interference to generate an aggregate transmit signal exhibiting beam-like qualities with more signal strength propagating in a given direction away from the antenna array 102.

In the context of signal reception, the signal conditioning circuits process the received signals (for instance, by separately controlling received signal phases) such that more signal energy is received when the signal is arriving at the antenna array 102 from a particular direction. Accordingly, the communication system 110 also provides directivity for reception of signals.

The relative concentration of signal energy into a transmit beam or a receive beam can be enhanced by increasing the size of the array. For example, with more signal energy focused into a transmit beam, the signal is able to propagate for a longer range while providing sufficient signal level for RF communications. For instance, a signal with a large proportion of signal energy focused into the transmit beam can exhibit high effective isotropic radiated power (EIRP).

In the illustrated embodiment, the transceiver 105 provides transmit signals to the signal conditioning circuits and processes signals received from the signal conditioning circuits. As shown in FIG. 5A, the transceiver 105 generates control signals for the signal conditioning circuits. The control signals can be used for a variety of functions, such as controlling the gain and phase of transmitted and/or received signals to control beamforming.

FIG. 5B is a schematic diagram of one example of beamforming to provide a transmit beam. FIG. 5B illustrates a portion of a communication system including a first signal conditioning circuit 114a, a second signal conditioning circuit 114b, a first antenna element 113a, and a second antenna element 113b.

Although illustrated as included two antenna elements and two signal conditioning circuits, a communication system can include additional antenna elements and/or signal conditioning circuits. For example, FIG. 5B illustrates one embodiment of a portion of the communication system 110 of FIG. 5A.

The first signal conditioning circuit 114a includes a first phase shifter 130a, a first power amplifier 131a, a first low noise amplifier (LNA) 132a, and switches for controlling selection of the power amplifier 131a or LNA 132a. Additionally, the second signal conditioning circuit 114b includes a second phase shifter 130b, a second power amplifier 131b, a second LNA 132b, and switches for controlling selection of the power amplifier 131b or LNA 132b.

Although one embodiment of signal conditioning circuits is shown, other implementations of signal conditioning circuits are possible. For instance, in one example, a signal conditioning circuit includes one or more band filters, duplexers, and/or other components.

In the illustrated embodiment, the first antenna element 113a and the second antenna element 113b are separated by a distance d. Additionally, FIG. 5B has been annotated with an angle θ, which in this example has a value of about 90° when the transmit beam direction is substantially perpendicular to a plane of the antenna array and a value of about 0° when the transmit beam direction is substantially parallel to the plane of the antenna array.

By controlling the relative phase of the transmit signals provided to the antenna elements 113a, 113b, a desired transmit beam angle θ can be achieved. For example, when the first phase shifter 130a has a reference value of 0°, the second phase shifter 130b can be controlled to provide a phase shift of about −2πf(d/v)cosθ radians, where f is the fundamental frequency of the transmit signal, d is the distance between the antenna elements, v is the velocity of the radiated wave, and π is the mathematic constant pi.

In certain implementations, the distance d is implemented to be about ½λ, where λ is the wavelength of the fundamental component of the transmit signal. In such implementations, the second phase shifter 130b can be controlled to provide a phase shift of about −πcosθ radians to achieve a transmit beam angle θ.

Accordingly, the relative phase of the phase shifters 130a, 130b can be controlled to provide transmit beamforming. In certain implementations, a baseband processor and/or a transceiver (for example, the transceiver 105 of FIG. 5A) controls phase values of one or more phase shifters and gain values of one or more controllable amplifiers to control beamforming.

FIG. 5C is a schematic diagram of one example of beamforming to provide a receive beam. FIG. 5C is similar to FIG. 5B, except that FIG. 5C illustrates beamforming in the context of a receive beam rather than a transmit beam.

As shown in FIG. 5C, a relative phase difference between the first phase shifter 130a and the second phase shifter 130b can be selected to about equal −2πf(d/v)cosθ radians to achieve a desired receive beam angle θ. In implementations in which the distance d corresponds to about ½λ, the phase difference can be selected to about equal to −πcosθ radians to achieve a receive beam angle θ.

Although various equations for phase values to provide beamforming have been provided, other phase selection values are possible, such as phase values selected based on implementation of an antenna array, implementation of signal conditioning circuits, and/or a radio environment.

### Examples of Mitigating Antenna Puncturing Arising From Sounding Reference Signaling

Certain communication systems simultaneously communicate over multiple frequency bands. For example, a 5G radio can simultaneously communicate both a NR TDD band and a 4G and/or 5G NR band during carrier aggregation (CA) or EN-DC operation. The 4G/5G NR band can operate using TDD or FDD.

In certain applications, the two frequency bands (for example, a first frequency band that is NR TDD a second frequency band that is LTE/NR FDD or TDD) share antenna feed paths in the front-end system without frequency selectivity by an antenna-plexer. Some of these operating scenarios also are specified to operate with simultaneous transmission of the first frequency band and reception of the second frequency band. One such example is n41+B25 CA or EN-DC.

In such operating scenarios, sounding reference signaling (SRS) is performed for the first frequency band (for example, NR TX TDD). Such SRS can include transmitting a known reference signal on each antenna for purposes of channel estimation and modeling. Such SRS signaling can interrupt the second frequency band DL RX signal by taking over the shared antenna for purposes of an SRS transmission. For example, a power amplifier for the NR TX TDD frequency band can be connected through a front-end switch (for instance, an antenna switch module or ASM) for a duration of time to transmit an SRS signal. During this time period (which may be as short as 1 uplink symbol), downlink connectivity for the second frequency band can be lost.

The effect of this puncturing on the second frequency band's downlink throughput is often very substantial and leads to SNR loss of varying degrees, depending on the downlink signal type. Here, SNR loss is defined as the amount of increased SNR required to attain a given throughput (say 95%), as compared to unpunctured operation.

Apparatus and methods for mitigating antenna puncturing arising from SRS are disclosed. In certain embodiments, a mobile device includes a front-end system operable to transmit over a first frequency band and to a receive over a second frequency band. The mobile device includes a radio operable to detect an antenna puncturing scenario arising from SRS signaling for the first frequency band for a first radio configuration in which each antenna of a group of antennas are used for receiving a data layer of the second frequency band. In response to detecting the antenna puncturing scenario, the radio indicates to a base station a second radio configuration in which a subset of the group of antennas are used at a given time for receiving the second frequency band to avoid the antenna puncturing scenario. This indication by the radio to the base station can occur at the establishment of the communication session during dedicated events such as radio resource configuration (RRC). The indication of reduced capability by the radio may also take the form of support for a lower number of data layers rather than a lower number of antennas.

Thus, rather than using the first radio configuration with a greater number of antennas/data layers, the mobile device communicates using the second radio configuration using fewer antennas and a corresponding lower number of data layers.

The inventors have recognized that throughput for a higher order radio configuration can be lower due to antenna puncturing than the throughput achieved for a lower order radio configuration without puncturing. For example, throughput degradation can be a function of DL modulation and coding scheme (MCS), gNodeB/eNodeB TX antenna configuration, UE/CPE RX antenna configuration, and/or propagation channel conditions, and the throughput for the higher order radio configuration with puncturing can be compared to the throughput for the lower order radio configuration to determine if overall network efficiency is improved by avoiding the antenna puncturing scenario.

In one example, a 4×4 antenna configuration with 4-layer transmission where 1 out of 4 antennas is punctured at a time (cycling between antennas for SRS for the frequency band) for a certain MCS signal may achieve low max throughput T1 at SNR=SNR1. However, the same MCS signal when operated as a 4×2 (or 4×3) antenna configuration with 2 (or 3) layer transmission where 2 (or 3) out of the 4 downlink antennas are dynamically selected for receiving the second frequency band so as to avoid puncturing entirely, may yield max throughput of T2 at SNR=SNR2. Additionally, when T2>T1, or if T2>=T1 and SNR2<SNR1, then a better network outcome is achieved.

Certain mobile phones disclosed herein are able to signal the network of limited capabilities for this CA or EN-DC combination of the first frequency band plus second frequency band, where the mobile phone supports limited antenna operations (for example, only a 4×3 or 4×2 antenna configuration for a scenario where the mobile phone has 4 antennas available, or otherwise only 3 or 2 UE DL antennas for the second frequency band, or otherwise only supports 2 or 3-layer DL reception for this combination). The effect of such operations is to compel the gNodeB/eNodeB scheduler to choose a lower radio configuration for this combination, while achieving better quality of service (QoS)/network outcome.

In certain implementations, the radio of the UE decodes all M paths even though the gNodeB/eNodeB has scheduled only N layers, where M is greater than N. In such a scheme, the puncturing of one of the M antennas (with N greater than or equal to M−1) will have little impact on downlink performance, as puncturing simply reduces data redundancy. The benefit of this approach is that neither the front-end system nor the baseband software needs to undertake any special procedures, but rather normal processing suffices.

Such an approach can have performance that is superior to that of a default punctured case where all M layers are scheduled by the gNodeB/eNodeB. Furthermore, such an approach need not require timed coordination in the UE between TDD uplink baseband and FDD downlink baseband, which often poses challenges in software design.

To improve the effectiveness when the UE decodes all paths, the base station (for example, gNodeB/eNodeB) can time-align the puncturing uplink symbol(s) with the demodulation reference symbol (DMRS) symbol(s) on the downlink whose throughput is being affected.

In one example, the base station schedules the downlink DMRS symbol(s) to overlap with (for instance, be synchronous with) the UL SRS symbol(s).

In another example, the base station schedules multiple downlink DMRS symbols, with more symbols offering a better statistical probability that one or more of them overlap the uplink SRS symbol(s) at the expense of a reduction of the available resources to transmit data and a limit to throughput. In certain implementations, UE only signals reduced layer/antenna support capability for downlink MCS cases where a tangible throughput benefit exists with multiple DMRS symbols scheduled, if time-alignment is not possible on the gNodeB/eNodeB.

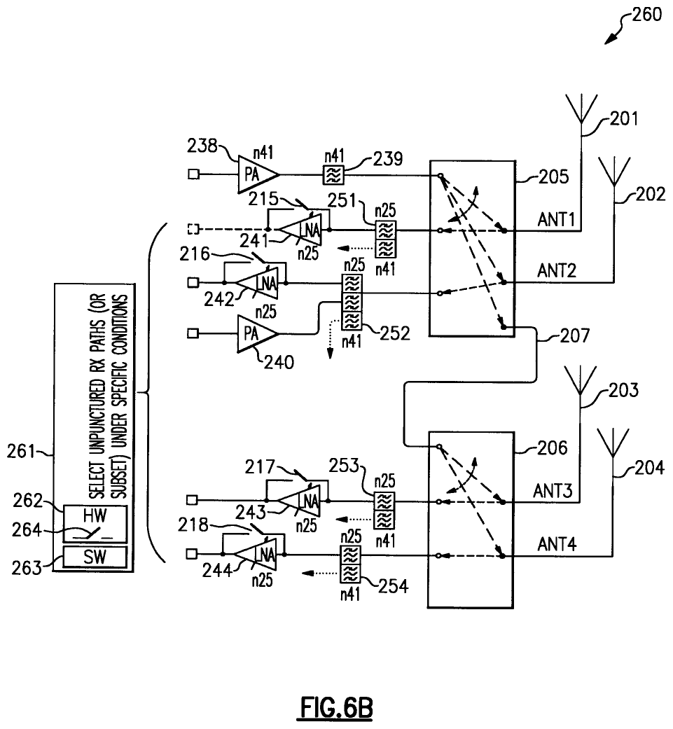

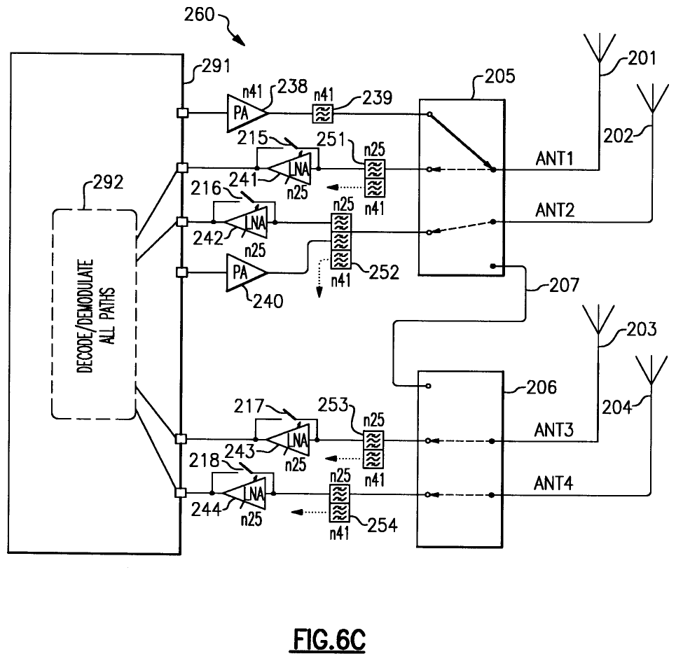

FIG. 6A is a schematic diagram of one embodiment of a front-end system 230. As shown in FIG. 6A, the front-end system 230 is connected to a first antenna 201, a second antenna 202, a third antenna 203, and a fourth antenna 204. Although not shown in FIG. 6A, the front-end system 230 is connected to a radio of the mobile device. Such a radio can include a baseband processor and a modem/transceiver.

In the illustrated embodiment, the front-end system 230 includes a first antenna switch 205, a second antenna switch 206, an antenna switch interconnection path 207, a power amplifier 208 for a first frequency band (TDD TX, in this example), a transmit filter 209 for the first frequency band, a first low noise amplifier (LNA) 211 for a second frequency band (FDD RX, in this example), a second LNA 212 for the second frequency band, a third LNA 213 for the second frequency band, a fourth LNA 214 for the second frequency band, a first bypass switch 215 for the first LNA 211, a second bypass switch 216 for the second LNA 212, a third bypass switch 217 for the third LNA 213, a fourth bypass switch 218 for the fourth LNA 214, a first antenna-plexer 221, a second antenna-plexer 222, a third antenna-plexer 223, and a fourth antenna-plexer 224.

Absent a mitigation technique, the NR TDD TX SRS signal outputted by the first power amplifier 208 to the antennas 201-204 (for example, for fast hopping SRS) can give rise to antenna puncturing for the second frequency band. Thus, the first frequency band SRS signal may interrupt the second frequency band DL signal and take over an antenna for SRS transmission whenever an SRS transmission is scheduled by the gNodeB/eNodeB/serving cell.

In a first example, the second frequency band is in CA with the first frequency band (which transmits SRS signals) or in EN-DC operation. In a second example, the second frequency band is FDD and thus assumed to be nominally operating DL as well as UL at any time. In a third example, the second frequency band is TDD and is not synchronized with the first frequency band such that UL for the first frequency band overlaps with DL for the second frequency band.

Such antenna puncturing causes loss of DL throughput (and consequently data rate) in the second frequency band. The antenna puncturing degradation leads to a loss of throughput that is dependent on the MCS and rank of the DL gNodeB/eNodeB transmission of the second frequency band as well as propagation channel conditions.

Furthermore, the loss of throughput may be excessively disproportionate to the number of antennas interrupted (punctured) and the puncturing-duty cycle of that antenna or the whole system of antennas.

A wide various of factors, including, but not limited, to size and cost constraints for UE, prevent the UE from provisioning sufficient antennas to avoid these puncturing scenarios.

The inventors herein have recognized that for certain combinations of DL MCS and rank, there are channel conditions where the effective DL throughput (absolute) under puncturing conditions is likely to be worse than or similar to what is achievable with lower MCS and rank. Furthermore, even when the throughput achievable is similar, the lower MCS/rank transmission may yield a larger SNR gain.

In such cases, the overall outcome (QoS/throughput) for the UE is better when operating at the lower MCS/rank condition. Since the 5G standard specifies that the gNodeB/eNodeB alone controls the scheduling of the DL signal, the UE can benefit from signaling certain additional information to the network/gNodeB/eNodeB related to a radio configuration in which a subset of the mobile device's antennas is used at a given time for receiving the second frequency band to avoid the antenna puncturing scenario.

Accordingly, for these combinations (which can be identified a-priori), the UE can signal support for a lower number of DL antennas or data-layers or both. In a first example, the UE can signal that the radio configuration should apply only for a particular combination of a first frequency band plus second frequency band for CA and/or EN-DC. In a second example, the UE can signal that the radio configuration should always apply when the frequency band combination is in operation.

The UE can use any suitable signaling mechanism to the base station, including signaling mechanisms that are already present for UE capability declaration and/or a new mechanism.

In the illustrated embodiment, rather than simultaneously using all four antenna 201-204 for DL communications on the second frequency band, the UE can declare support for a lower number of DL antennas (for instance, 2 or 3 versus 4) and/or a lower number of DL data layers (for instance 2 or 3 versus 4).

By forcing a lower number of DL antennas or layers, the gNodeB/eNodeB may only schedule a lower number of DL data layers, which will achieve an overall better outcome/QoS for the DL.

FIG. 6B is a schematic diagram of another embodiment of a front-end system 260. The front-end system 260 is connected to a first antenna 201, a second antenna 202, a third antenna 203, and a fourth antenna 204.

In the illustrated embodiment, the front-end system 260 includes a first antenna switch 205, a second antenna switch 206, an antenna switch interconnection path 207, a power amplifier 238 for a first frequency band (n41, in this example), a transmit filter 239 for the first frequency band, a first LNA 241 for a second frequency band (n25, in this example), a second LNA 242 for the second frequency band, a third LNA 243 for the second frequency band, a fourth LNA 244 for the second frequency band, a first bypass switch 215 for the first LNA 241, a second bypass switch 216 for the second LNA 242, a third bypass switch 217 for the third LNA 243, a fourth bypass switch 248 for the fourth LNA 214, a first n25/n41 antenna-plexer 251, a second n25/n41 antenna-plexer 252, a third n25/n41 antenna-plexer 253, and a fourth n25/n41 antenna-plexer 254.

The front-end system 260 of FIG. 6B is similar to the front-end system 230 of FIG. 6A, except that the front-end system 260 of FIG. 6B is implemented for a specific example in which the first frequency band is n41 and the second frequency band is n25.

In this example, the front-end system 260 operates with a radio configuration in which not all of the antennas are used for receiving the n25 at a given time. Rather, a subset of the antennas is used to avoid antenna puncturing.

The subset is selected by a selection block 261, which can include hardware (HW) 262 and/or software (SW) 263. For example, the subset used can be chosen by either physically disconnecting a given antenna using a switch 264 (a hardware solution) or by not using the data stream in a baseband processor or modem (a software solution).

Thus, in some embodiments a subset of unpunctured paths is selected in hardware (using a front-end system, switch-selection, and/or transceiver) with a reduced number of data layers negotiated for transmission. However, in other embodiments, a subset of unpunctured paths is selected in software (baseband/modem) with a reduced number of data layers negotiated for transmission. When using hardware and/or software methods, the punctured path can be fully disregarded or used to provide another function, such as RX diversity (whether by selection-diversity or another technique).

In the scenarios discussed above, the selection of RX paths is dynamic and in accordance with the SRS-scheme. When the SRS-scheme (timing) is pre-negotiated between the UE and the gNodeB/eNodeB, then the selection algorithm may be pre-determined. In other cases, the selection algorithm is adapted based on the modem/transceiver's decoding of gNodeB/eNodeB instructions to transmit SRS signals. Such adaptation can include MIPI instructions to alter ASM/switch configurations in the RFFE to accommodate SRS transmission.

In some embodiments, negotiation of fewer number of data-layers for gNodeB/eNodeB transmission is established by UE capability-signaling, for instance, during RRC configuration.

Such UE capability-signaling can cover NR TDD plus LTE/NR FDD/asynchronous TDD and can be specified (for instance, using data stored in a memory, such as a look-up table) as taking effect when this CA or EN-DC combination occurs.

Instead of SRS signal puncturing/interrupting the DL signal by taking over the antenna-feed/trace from the latter (switching over), it is also possible to route the SRS signal to a diplexer (or other antenna multiplexer). For instance, one filter of the diplexer is the TX filter of the SRS-band and the other filter is the RX filter of the DL-band. These can then be routed on to a common antenna-feed/trace, so that there is no takeover/puncturing of the DL path.

In such a case, the DL signal may still suffer some degradation—either through the impedance discontinuity on the TX filter side (when SRS signal is switched in) or by limited isolation between the SRS signal and the DL signal (across the diplexer). Such degradation may also be addressed by the techniques described above. For example, for lower DL signal configurations (MCS/layers) where the degradation is small, this method may completely avoid puncturing effects. For higher signal configurations, the UE may be able to signal and use the reduced capability to avoid serious disruptions, if warranted.

FIG. 6C is a schematic diagram of another embodiment of a front-end system 260 coupled to a radio 291. The radio 291 can include a baseband processor and a modem/transceiver.

The front-end system 260 includes a first antenna switch 205, a second antenna switch 206, an antenna switch interconnection path 207, a power amplifier 238 for a first frequency band (n41, in this example), a transmit filter 239 for the first frequency band, a first LNA 241 for a second frequency band (n25, in this example), a second LNA 242 for the second frequency band, a third LNA 243 for the second frequency band, a fourth LNA 244 for the second frequency band, a first bypass switch 215 for the first LNA 241, a second bypass switch 216 for the second LNA 242, a third bypass switch 217 for the third LNA 243, a fourth bypass switch 248 for the fourth LNA 214, a first n25/n41 antenna-plexer 251, a second n25/n41 antenna-plexer 252, a third n25/n41 antenna-plexer 253, and a fourth n25/n41 antenna-plexer 254.

The front-end system 260 of FIG. 6C is similar to the front-end system 230 of FIG. 6A, except that the front-end system 260 of FIG. 6C is implemented for a specific example in which the first frequency band is n41 and the second frequency band is n25.

Although shown for the context of n41/n25, other frequency bands can be used. For example, the front-end system 230 of FIG. 6A can be coupled to the radio 291 of FIG. 6C.

In the illustrated embodiment, the radio 291 decodes/demodulates all paths 292.

Accordingly, the radio 291 of the UE decodes all M paths even though the gNodeB/eNodeB has scheduled only N layers, where M is greater than N. In such a scheme, the puncturing of one of the M antennas (with N greater than or equal to M−1) will have little impact on downlink performance, as puncturing simply reduces data redundancy.

The benefit of this approach is that neither the front-end system nor the baseband software of the UE need to undertake any special procedures, but rather normal processing suffices. Moreover, such an approach can have performance that is superior to that of a default punctured case where all M layers are scheduled by the gNodeB/eNodeB. Furthermore, such an approach need not require timed coordination in the UE between TDD uplink baseband and FDD downlink baseband, which often poses challenges in software design.

In certain implementations, the base station (for example, the gNodeB/eNodeB) overlaps downlink DMRS symbol(s) with uplink SRS symbol(s) and/or schedules multiple downlink DMRS symbols with more symbols offering a better statistical probability that one or more of them overlap the uplink SRS symbol(s). Time-aligning the puncturing uplink symbol(s) with the DMRS symbol(s) improves the effectiveness when the UE decodes all paths.

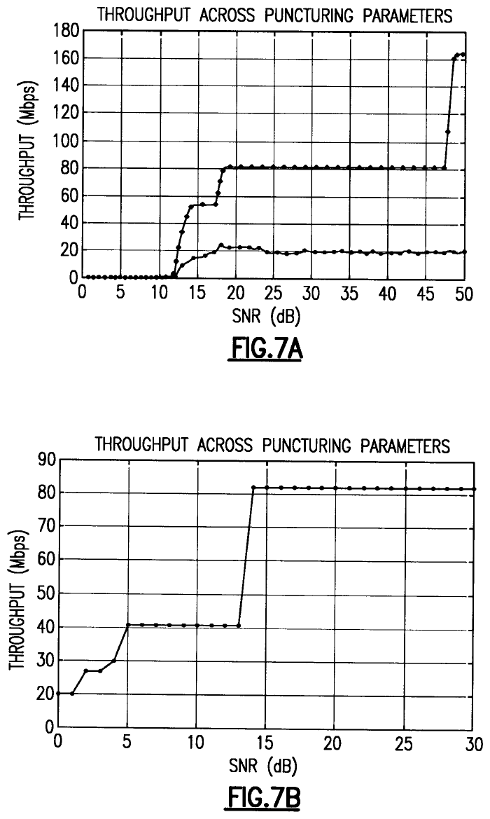

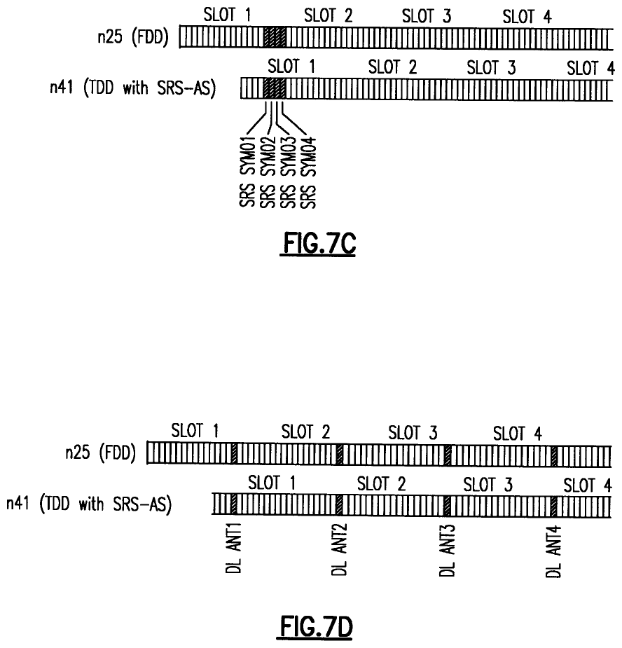

FIG. 7A is a graph of one example of throughput versus signal-to-noise ratio (SNR) for 4×4 4-layer 64 QAM with and without puncturing. The graph includes a top line representing throughput without puncturing, and a lower line representing degraded throughput arising from puncturing. The graphs are for a MCS19 signal with 51 resource blocks (RBs), transmitted across a radio propagation channel that is emulated by the CDL-C channel model described in the 3GPP 5G NR standard.

FIG. 7B is a graph of one example of throughput versus SNR for 4×2 2-layer 64 QAM without puncturing. The graph is also for a MCS19 signal with 51 RBs, transmitted across the same CDL-C channel as before.

As shown by a comparison of FIG. 7B to FIG. 7A, the lower order radio configuration without puncturing can achieve superior throughput as compared to the higher order radio configuration with puncturing.

FIG. 7C is a graph of a first example of communication time slots for n25 and n41 communications.

The depicted n41 SRS-AS sequence can occur whenever required by the gNodeB/eNodeB and base station or network.

In some embodiments, a hardware reconfiguration (for example, switches) are used in the front-end system to open-circuit and/or physically switch OFF the specific RX path that is negatively affected by the TDD SRS-AS puncturing events.

In other embodiments, a constant RFFE connectivity is used and the transceiver (or RFIC) and baseband modem demodulate all paths but do not use or drop the problem data that occurs during puncturing events. In some embodiments, using constant RFFE connectivity, the baseband modem will choose which data paths to use for decoding and demodulation, while discarding other data paths without decoding them.

Thus, in some embodiments continual operation of a frequency band (for instance, n25) on all antennas (for instance, 4) can be performed, but fewer layers (for instance, 2 or 3 instead of all 4) can be used for demodulation. In such embodiments, the antenna that suffers from the puncturing event can be totally disregarded or in some implementations used to do an RX demodulation of a duplicate of the affected layer to benefit with RX diversity gain (apart from the time when the puncturing may irreparably damage the concurrent n25 Rx symbol, in which case the redundancy enables that bit to be well received on a clean RX path that does not suffer from puncturing).

FIG. 7D is a graph of a second example of communication time slots for n25 and n41 communications.

In comparison to the example of FIG. 7C, the sequence for the SRS-AS in the example of FIG. 7D is spaced out more in time and enables more time to get ready for any potential RF front-end reconfiguration events.

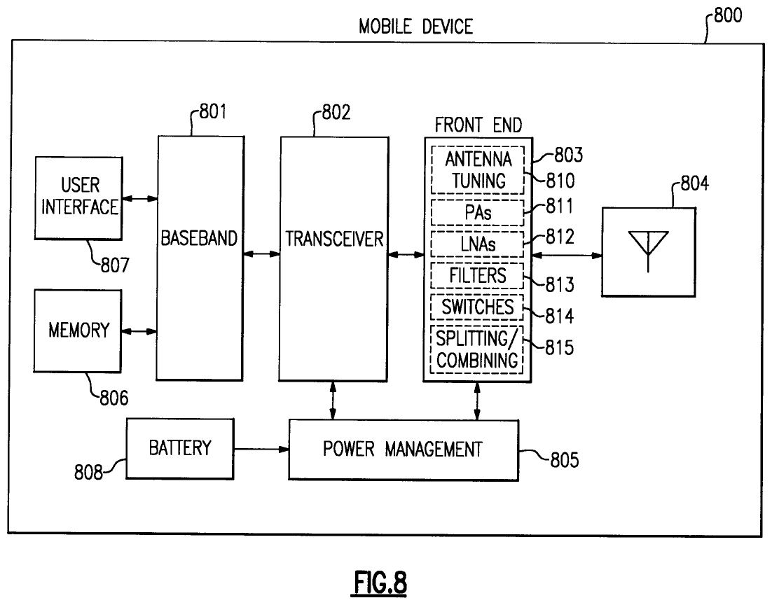

FIG. 8 is a schematic diagram of one embodiment of a mobile device 800. The mobile device 800 includes a baseband system 801, a transceiver 802, a front-end system 803, antennas 804, a power management system 805, a memory 806, a user interface 807, and a battery 808.

The mobile device 800 can be used communicate using a wide variety of communications technologies, including, but not limited to, 2G, 3G, 4G (including LTE, LTE-Advanced, and LTE-Advanced Pro), 5G NR, WLAN (for instance, WiFi), WPAN (for instance, Bluetooth and ZigBee), WMAN (for instance, WiMax), and/or GPS technologies.

The transceiver 802 generates RF signals for transmission and processes incoming RF signals received from the antennas 804. It will be understood that various functionalities associated with the transmission and receiving of RF signals can be achieved by one or more components that are collectively represented in FIG. 8 as the transceiver 802. In one example, separate components (for instance, separate circuits or dies) can be provided for handling certain types of RF signals. Such separate transceiver circuits or dies can receive separate RF split signals from the front-end systems implemented in accordance with the teachings herein.

The front-end system 803 aids in conditioning signals transmitted to and/or received from the antennas 804. In the illustrated embodiment, the front-end system 803 includes antenna tuning circuitry 810, power amplifiers (PAS) 811, low noise amplifiers (LNAs) 812, filters 813, switches 814, and signal splitting/combining circuitry 815. The front-end system 803 can be implemented in accordance with any of the embodiments herein.

With continuing reference to FIG. 8, the front-end system 803 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 800 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 804 can include antennas used for a wide variety of types of communications. For example, the antennas 804 can include antennas for transmitting and/or receiving signals associated with a wide variety of frequencies and communications standards.

In certain implementations, the antennas 804 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 800 can operate with beamforming in certain implementations. For example, the front-end system 803 can include amplifiers having controllable gain and phase shifters having controllable phase to provide beam formation and directivity for transmission and/or reception of signals using the antennas 804. For example, in the context of signal transmission, the amplitude and phases of the transmit signals provided to the antennas 804 are controlled such that radiated signals from the antennas 804 combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas 804 from a particular direction. In certain implementations, the antennas 804 include one or more arrays of antenna elements to enhance beamforming.

The baseband system 801 is coupled to the user interface 807 to facilitate processing of various user input and output (I/O), such as voice and data. The baseband system 801 provides the transceiver 802 with digital representations of transmit signals, which the transceiver 802 processes to generate RF signals for transmission. The baseband system 801 also processes digital representations of received signals provided by the transceiver 802. As shown in FIG. 8, the baseband system 801 is coupled to the memory 806 of facilitate operation of the mobile device 800.

The memory 806 can be used for a wide variety of purposes, such as storing data and/or instructions to facilitate the operation of the mobile device 800 and/or to provide storage of user information.

The power management system 805 provides a number of power management functions of the mobile device 800. In certain implementations, the power management system 805 includes a PA supply control circuit that controls the supply voltages of the power amplifiers 811. For example, the power management system 805 can be configured to change the supply voltage(s) provided to one or more of the power amplifiers 811 to improve efficiency, such as power added efficiency (PAE).

As shown in FIG. 8, the power management system 805 receives a battery voltage from the battery 808. The battery 808 can be any suitable battery for use in the mobile device 800, including, for example, a lithium-ion battery.

### Applications

Some of the embodiments described above have provided examples in connection with mobile devices. However, the principles and advantages of the embodiments can be used for a wide range of RF communication systems. Examples of such RF communication systems include, but are not limited to, mobile phones, tablets, base stations, network access points, customer-premises equipment (CPE), laptops, and wearable electronics.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “may,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A mobile device comprising:
a plurality of antennas;
a front-end system coupled to the plurality of antennas and configured to transmit over a first frequency band and to a receive over a second frequency band; and
a radio configured to control the front-end system to perform a sounding reference signaling for the first frequency band on the plurality of antennas, the radio operable to detect an antenna puncturing scenario arising from the sounding reference signaling for a first radio configuration in which each antenna of the plurality of antennas is used for receiving a corresponding data layer of the second frequency band, the radio further configured to indicate to a base station a second radio configuration in which a subset of the antennas are used at a given time for receiving the second frequency band to avoid the antenna puncturing scenario.

2. The mobile device of claim 1 wherein the subset of the antennas is selected in hardware.

3. The mobile device of claim 2 wherein the subset of the antennas is selected using at least one switch in the front-end system or radio.

4. The mobile device of claim 1 wherein the subset of the antennas is selected using software in the radio.

5. The mobile device of claim 1 wherein the subset of the antennas is dynamically changed by the radio over time.

6. The mobile device of claim 1 wherein the subset of the antennas excludes a punctured antenna.

7. The mobile device of claim 6 wherein the punctured antenna is used by the radio for signal diversity.

8. The mobile device of claim 1 wherein the radio decodes a plurality of data layers received from a base station on the plurality of antennas, a number of the plurality of antennas greater than a number of the plurality of data layers.

9. The mobile device of claim 1 wherein the second radio configuration has a multiple-input multiple-output order that is smaller than that of the first radio configuration.

10. The mobile device of claim 9 wherein the first radio configuration has a 4×4 order and the second radio configuration has a 4×2 order or a 4×3 order.

11. The mobile device of claim 1 wherein the second radio configuration is established by a capability signaling from the mobile device to a base station.

12. The mobile device of claim 1 wherein the first frequency band is a fifth generation frequency band that is time-division duplexed.

13. The mobile device of claim 12 wherein the second frequency band is fourth generation frequency band serving as an anchor carrier for dual connectivity.

14. The mobile device of claim 12 wherein the second frequency band is time-division duplexed and asynchronous with the first frequency band.

15. A method of radio frequency communication, the method comprising:
transmitting over a first frequency band and receiving over a second frequency band using a front-end system of a mobile device;
controlling the front-end system to perform a sounding reference signaling for the first frequency band on a plurality of antennas of the mobile device;
detecting an antenna puncturing scenario arising from the sounding reference signaling for a first radio configuration in which each antenna of the plurality of antennas is used for receiving a corresponding data layer of the second frequency band; and
indicating to a base station a second radio configuration in which a subset of the antennas are used at a given time for receiving the second frequency band to avoid the antenna puncturing scenario.

16. The method of claim 15 further comprising dynamically changing the subset of the antennas over time.

17. The method of claim 15 wherein the second radio configuration has a multiple-input multiple-output order that is smaller than that of the first radio configuration.

18. The method of claim 15 further comprising establishing the second radio configuration by a capability signaling from the mobile device to a base station.

19. A radio system for user equipment, the radio system comprising:
a front-end system configured to transmit over a first frequency band and to a receive over a second frequency band; and
a radio configured to control the front-end system to perform a sounding reference signaling for the first frequency band, the radio operable to detect an antenna puncturing scenario arising from the sounding reference signaling for a first radio configuration in which each antenna of the plurality of antennas is used for receiving a corresponding data layer of the second frequency band, the radio further configured to indicate to a base station a second radio configuration in which a subset of the antennas are used at a given time for receiving the second frequency band to avoid the antenna puncturing scenario.

20. The radio system of claim 19 wherein the second radio configuration has a multiple-input multiple-output order that is smaller than that of the first radio configuration.
